(19) United States
(12) Patent Application Publication
(10) Pub. No.: US 2010/0225139 A1
(43) Pub. Date: Sep. 9, 2010

(54) Portable automobile (GPS) attachment cradle

(76) Inventor: Gerald L. Losser, Gloucester, VA (US)

Correspondence Address: Gerald L. Losser, 4639 Old Forest Road, Gloucester, VA, 23061, US

(21) Appl. No.: 12/657,008

(22) Filed: Jan. 13, 2010

Related U.S. Application Data
(60) Provisional application No. 61/209,663, filed on Mar. 9, 2009.

(51) Int. Cl. B60J 3/00

(52) U.S. Cl. 296/97.5

(57) ABSTRACT

A portable GPS docking device that clamps onto an automobile Sun Visor, to provide a driver a direct heads up view on the road way.

The location of the GPS screen and audio instructions, permit fewer visual distractions that are caused by placement the other types of docking devices that are being positioned onto automotive Windshields and Dashboards.

### BACK GROUND OF INVENTION

This Invention relates to a portable mounting docking device that clamps a Global Positioning System (GPS) on the top side of a automobile sun visor by using the Attachment Cradle.

### BRIEF SUMMARY OF INVENTION

In the prior art various methods are used to attach GPS docking systems onto the interior of automobiles that are placed in areas around the driver for viewing a GPS navigation screen to select map and route destinations,

Present devices to attach a GPS docking units are made by selecting (a) Permanent placement inside the auto dashboard, (b) Suction Cups for holding devices on windshield or on top of dashboard, (c) Permanent placement of adhesive for bracket stands onto dashboard, (d) the use of weighed down mat based holders.

The placement and location of the GPS docking device is important that it does not create a distraction and create an adverse effect on the drivers ability to pay attention to traffic conditions on the road way ahead.

### SUMMARY

The Portable (GPS) Attachment Cradle is designed to be attached to the top edge of the Sun Visor to allow the driver a close up view of the GPS screen with audio directions an permits a quick visual response for safe driving with direct view of the road way, In the visor area the GPS screen is also visible and is shielded inside away from the glare of sunlight.

### BRIEF DESCRIPTION OF INVENTION

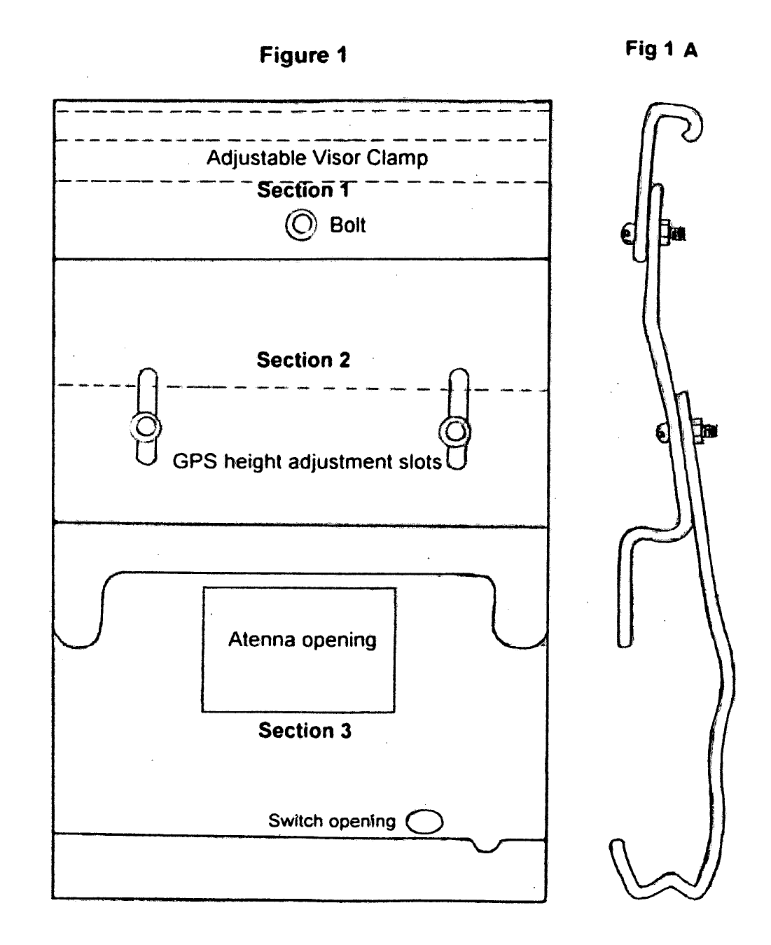

FIG. 1 Page 3 Drawing 1 Section 1 Top front view shows the top horizontal clamping section that forms a curved around configuration that attaches on the Automobile Sun Visor, a centered bolt hole is used to align the GPS screen in a horizontal position to compensate for the slope of the Sun Visor.

Drawing 1 section 2 Middle view part of the holding clamp at the top GPS with vertical hole slots to make adjustments for size.

Drawing 1 section 3 Bottom view Plastic material forms a curve around clamp at bottom of GPS screen showing two cut out open sections at the for antenna and switch.

Drawing 1 sections 1 2 3 Side View Assembly shows the placement of the three Sections attached together in the configuration to hold the GPS

### DESCRIPTION OF INVENTION

A Portable Cradle unit is designed to encircle a GPS by using three individual separate adjustable configured plastic sections layered on top of each and is held together by three bolts. The upper section clamps over the edge of an Automobile Sun Visor and is held on by the horizontal curved channel. The middle section of cradle has channel slots to allow adjustment for the height of individual screen sizes. The bottom section clamps underneath the GPS to secure it in the cradle.

1. This Invention relates to a Portable Automotive Cradle device that holds a Ground Positioning Sensor (GPS) onto a automotive Sun Visor, the Cradle device on Sun Visor gives an above frontal view of the GPS screen that is shielded from the glare of the sun and same time gives the driver has a full direct view of traffic on the road ahead. The advantage GPS Cradle device it gives a driver a close visual map and audio direction,
No Permanent or mounted hardware on dash board on windshield is needed.
